(19) United States
(12) Patent Application Publication
(10) Pub. No.: US 2007/0297753 A1
(43) Pub. Date: Dec. 27, 2007

(54) IMAGE CORRECTING APPARATUS

(76) Inventors: Tsutomu Usui, Tokyo (JP); Hiroshi Chiba, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/627,463

(22) Filed: Jan. 26, 2007

(30) Foreign Application Priority Data
Jun. 8, 2006 (JP) 2006-159236

(51) Int. Cl. H04N 5/91

(52) U.S. Cl. 386/46

(57) ABSTRACT

An object of the present invention is to provide an image correcting apparatus capable of performing zoom processing or mask processing on an image output from an imaging device, such as an image display device or an image monitoring/recording device, or on a reproduced image from an image recorder, in such a way as to adjust the exposure or luminance of the zoomed portion or the unmasked portion of the image to an optimum level and thereby allow display of a clear image.

An image correcting apparatus of the present invention comprises: image input/output interfaces; zoom processing means for zooming an area of an input image; luminance histogram processing means for creating a luminance histogram of the zoomed area or an unmasked area of the image; and exposure correction processing means for adjusting the exposure or luminance of the zoomed area or the unmasked area to an appropriate level based on the luminance histogram created by the luminance histogram processing means.

### CLAIM OF PRIORITY

The present application claims priority from Japanese application serial No. JP 2006-159236, filed on Jun. 8, 2006, the content of which is hereby incorporated by reference into this application.

### BACKGROUND OF THE INVENTION

1. Field of the Invention

The present invention relates to image correcting apparatus.

2. Description of the Related Art

The prior art includes Japanese Laid-Open Patent Publication No. 5-244489 (1993). This publication states that a problem with conventional image display apparatuses for intercoms, monitoring cameras, etc. is that since the iris control is performed based on the luminance of the pixels in the entire imaging area, a portion of the screen display may not be clear or may not provide the details of the displayed object(s) (even if enlarged, or zoomed in) if there is a large difference between the luminance of that portion and the luminance of the entire imaging area. To solve this problem, the above publication discloses an image display apparatus that includes a zoom area luminance measuring unit for measuring the luminance of an area being zoomed and an iris control unit for controlling the iris based on the measured luminance.

### SUMMARY OF THE INVENTION

When a backlighted person by the window is photographed from inside a room using a video camera or an electronic still camera, or when a person in a room is photographed from outside the house using such a camera, the captured image of the person is underexposed and hence dark and unclear if ordinary exposure control is performed on the image, even though the image of the landscape outside is properly exposed.

Even if the above captured image of the person is enlarged or subjected to zoom processing so as to zoom in on the person), the resultant image is still underexposed and appears too dark since the exposure control is performed based on the average luminance of the entire screen displayed before the zoom process.

To allow an imaging apparatus to properly zoom an area of an image having spatial variations in luminance, some conventional exposure correcting techniques detect, or measure, the luminance of this zoom area and controls the iris of the apparatus based on the detected luminance so as to correct the exposure for the area.

The technique disclosed in the above patent publication measures the luminance of an area to be zoomed in by use of a zoom area luminance measuring unit and then controls the iris of the imaging unit based on the measured luminance by use of an iris control unit, as described above.

However, conventional techniques (such as that described above) that control the iris of the imaging unit are disadvantageous in that they cannot be applied to cameras with no iris control function. Further, the iris control unit (if employed) must be set within the same enclosure as the imaging unit, or it must be connected to the imaging unit if it is installed at a separate location, incurring additional costs, that is, the cost of the iris control unit and the cost of installing and connecting it, etc. For example, the cost associated with such iris control is significantly higher in the case of a monitoring system in which an image output from the camera is zoomed and displayed by a separate recorder.

These problems must be overcome to properly perform zoom processing or mask processing on an output image or a reproduced image from an image display device or an image recorder at reduced cost. Thus, there is a need for a technique to optimize the exposure (or luminance level) of a zoomed image or an unmasked image to provide a clear image display.

It is, therefore, an object of the present invention to provide an image correcting apparatus having enhanced performance.

To achieve the above object, an exemplary aspect of the present invention provides an image correcting apparatus capable of extracting an area of an image represented by received image information (for example, through zoom processing or mask processing), creating a luminance histogram of the extracted area, and correcting the exposure or luminance level of the area based on this luminance histogram.

It should be noted that the following description and the appended claims provide more detailed aspects of the present invention.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an image correcting apparatus according to a first embodiment of the present invention;

FIG. 2 is a diagram showing an exemplary application of the image correcting apparatus of the first embodiment;

FIG. 3 is a block diagram showing an image correcting apparatus according to a second embodiment of the present invention;

FIG. 4 is a block diagram showing an image correcting apparatus according to a third embodiment of the present invention;

FIG. 5 is a diagram showing an exemplary application of the image correcting apparatus according to the present invention;

FIG. 6 is a block diagram showing an image correcting apparatus according to a fourth embodiment of the present invention;

FIG. 7 is a block diagram showing an image correcting apparatus according to a fifth embodiment of the present invention;

FIG. 8 is a diagram showing an exemplary application of an image correcting apparatus according to the present invention; and

FIG. 9 is a flowchart showing an exemplary image correction processing flow according to the present invention.

### DETAILED DESCRIPTION OF THE PREFERRED EMBODIMENTS

following are reference numerals used in the this specification.
101 . . . image input I/F
102 . . . zoom processing means
103 . . . histogram processing means
104 . . . exposure correction processing means
105 . . . image output I/F
201 . . . input image
202 . . . zoom area within input image
203 . . . image that has been subjected to zoom processing
204 . . . image that has been subjected to zoom processing and exposure correction processing
301 . . . image input/IF
302 . . . zoom processing means
303 . . . histogram processing means
304 . . . exposure correction processing means
305 . . . image output I/F
306 . . . recording medium
401 . . . image input I/F
402 . . . mask processing means
403 . . . histogram processing means
404 . . . exposure correction processing means
405 . . . image output I/F
406 . . . recording medium
501 . . . input image
502 . . . image that has been subjected to mask processing
503 . . . image that has been subjected to mask processing and exposure correction processing
601 . . . image input I/F
602 . . . processor
603 . . . image output I/F
701 . . . image input I/F
702 . . . processor
703 . . . image output I/F
704 . . . recording medium
801 . . . image monitor
901 . . . zoom processing
902 . . . mask processing
903 . . . histogram processing
904 . . . exposure correction processing

The present invention will now be described in detail with reference to the accompanying drawings.

Preferred embodiments of the present invention will be described with reference to the accompanying drawings.

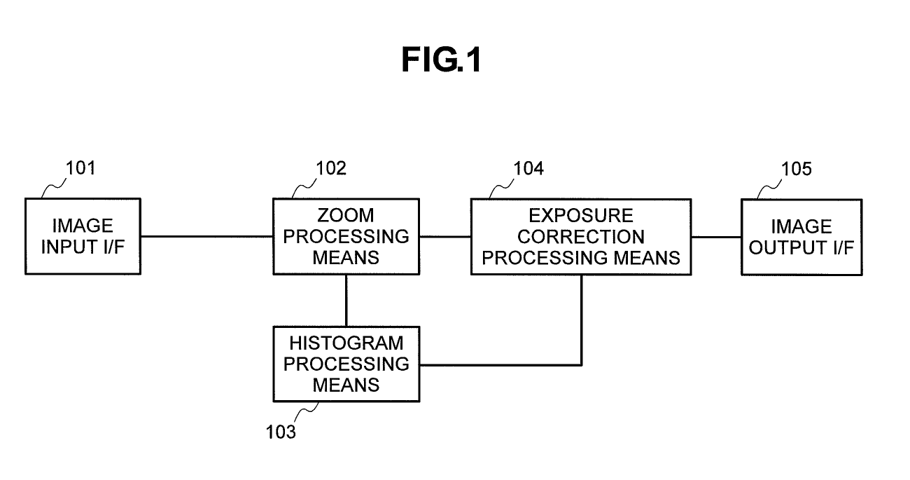

FIG. 1 is a block diagram showing an image correcting apparatus according to a first embodiment of the present invention.

Referring to the figure, reference numeral 101 denotes one or more image input interfaces (hereinafter referred to as image input I/F); 102, a zoom processing means; 103, a histogram processing means; 104, an exposure correction processing means; and 105, one or more image output interfaces (hereinafter referred to as image output I/F).

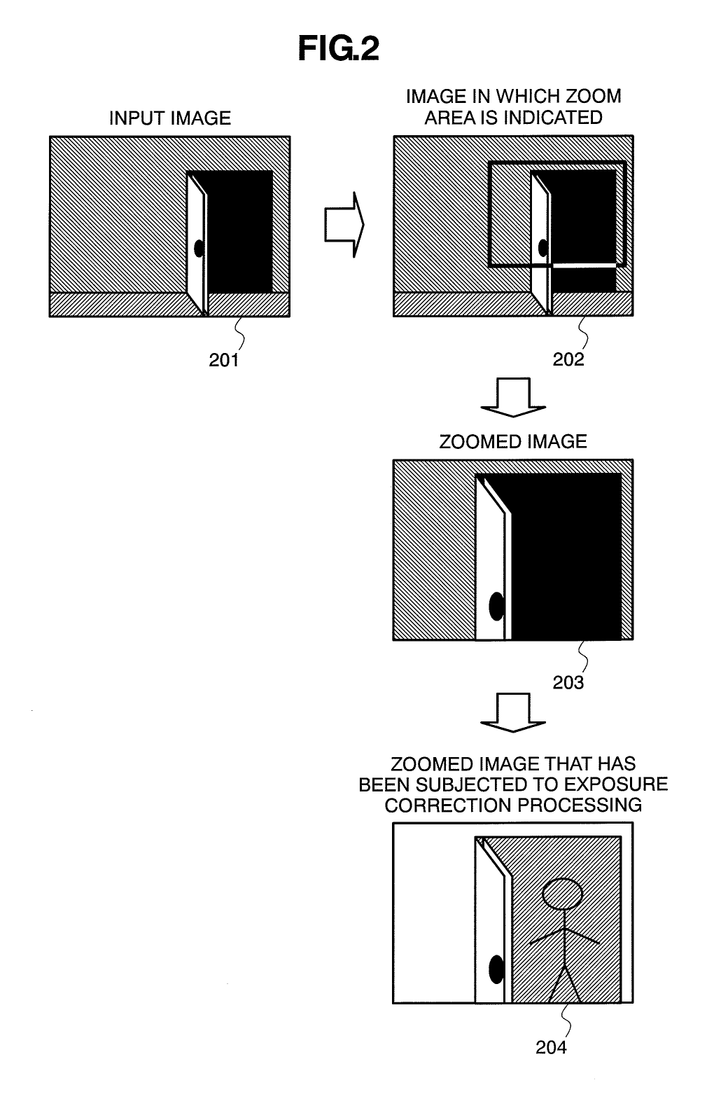

FIG. 2 is a diagram showing images generated by performing zoom processing and exposure correction processing on an input image from a monitoring camera, etc. by use of the image correcting apparatus of the first embodiment. The input image shows a scene that includes a building wall with a door left open to partially reveal the inside of the building. The luminance of the wall, etc. outside is high while that of the inside of the building is low. That is, there is a large luminance difference between these objects, and the high luminance area in the image, or scene, is significantly larger than the low luminance area.

Specifically, reference numeral 201 denotes the input image from a monitoring camera, etc., showing a building wall with a door left open to partially reveal the inside of the building, as described above. Reference numeral 202 denotes an image which is a result of adding to the image 201 a rectangle indicating an area to be subjected to zoom processing. Reference numeral 203 denotes an image generated by performing zoom processing on the indicated area. Reference numeral 204 denotes an image generated by performing exposure correction processing on the image 203 that has been subjected to the zoom processing.

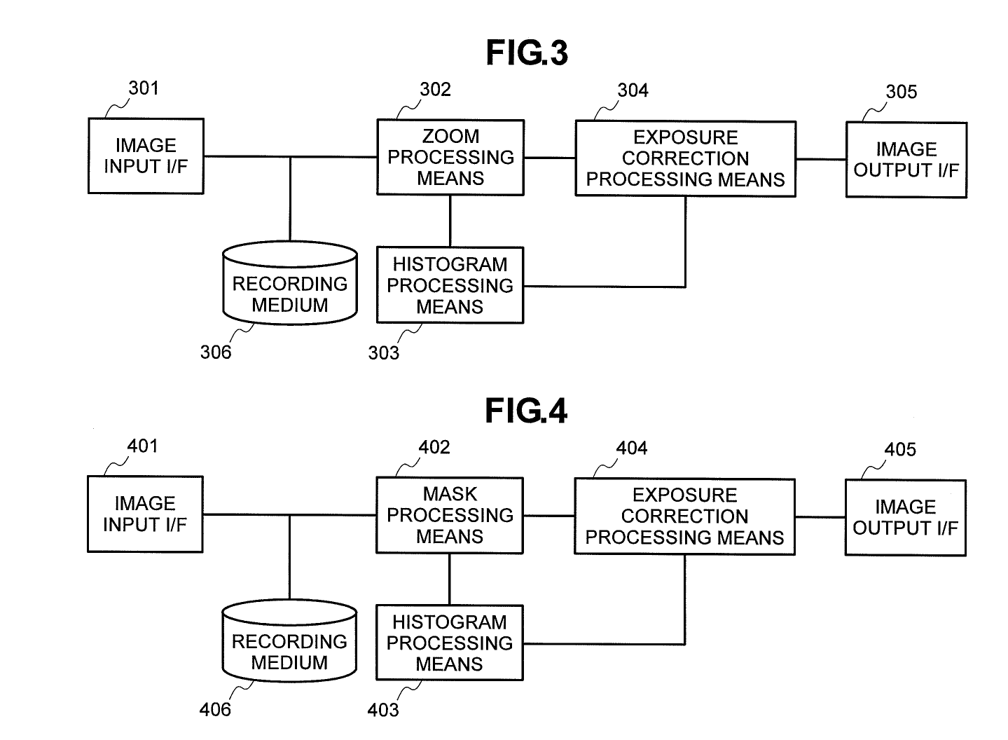

FIG. 3 is a block diagram showing an image correcting apparatus according to a second embodiment of the present invention.

Referring to the figure, reference numeral 306 denotes a recording medium. Reference numerals 301 and 305 denote interfaces corresponding to the interfaces 101 and 105 shown in FIG. 1, respectively. Reference numerals 302 to 304 denote means corresponding to the means 102 to 104 shown in FIG. 1, respectively.

FIG. 4 is a block diagram showing an image correcting apparatus according to a third embodiment of the present invention. Reference numeral 402 denotes a mask processing means. Reference numerals 401 and 405 denote interfaces corresponding to the interfaces 101 and 105 shown in FIG. 1, respectively. Reference numerals 402 to 404 denote means corresponding to the means 102 to 104 shown in FIG. 1, respectively. Reference numeral 406 denotes means corresponding to means 306 in FIG. 3.

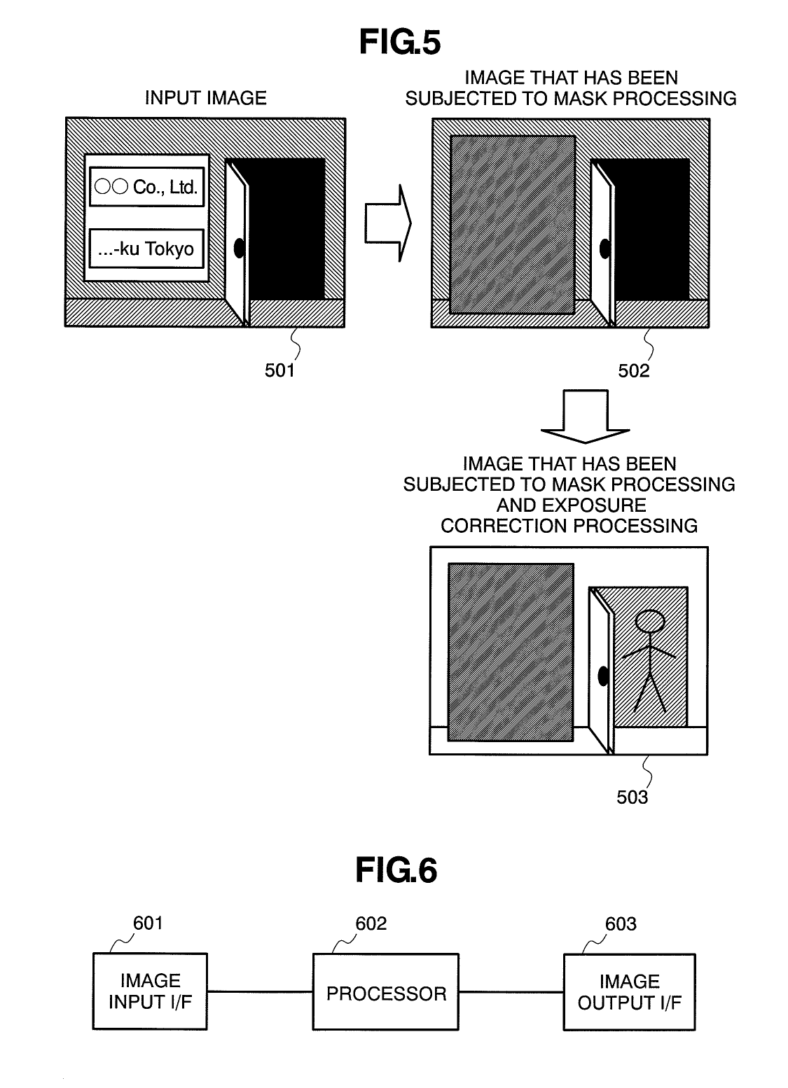

FIG. 5 is a diagram showing images generated by performing mask processing and exposure correction processing on an input image from a monitoring camera, etc. by use of the image correcting apparatus of the third embodiment. The input image shows a scene that includes a building wall with a door left open to partially reveal the inside of the building. The luminance of the wall, etc. outside is high while that of the inside of the building is low. That is, there is a large luminance difference between these objects, and the high luminance area in the image, or scene, is significantly larger than the low luminance area.

Specifically, reference numeral 501 denotes the input image from a monitoring camera, etc., showing a building wall with a door left open to partially reveal the inside of the building, as described above. Reference numeral 502 denotes an image generated by performing mask processing on the input image 501. Reference numeral 503 denotes an image generated by performing exposure correction processing on the image 502 that has been subjected to the mask processing.

The operation of the image correcting apparatus of the first embodiment will now be described with reference to FIG. 1. The image input I/F 101 receives an image signal from, for example, a monitoring camera. It should be noted that when the monitoring camera captured this image signal, it performed exposure control based on the average luminance of the entire screen display or the luminance level of a particular portion thereof. The zoom processing means 102 performs zoom processing on an area of the input image signal. This area is specified manually or automatically. Then, the histogram processing means 103 creates a luminance histogram based on the image signal on which the zoom processing means 102 has performed the zoom processing. After that, based on histogram data received from the histogram processing means 103, the exposure correction processing means 104 performs exposure correction on the image signal that has been subjected to the zoom processing. The image data or signal that has been subjected to the exposure correction is output to an external monitor, etc. through the image output I/F 105.

FIG. 2 shows exemplary images generated by the image correcting apparatus shown by the block diagram of FIG. 1. Referring to FIG. 2, the image 201 input to the image input I/F shows a scene that includes a building wall with a door left open to partially reveal the inside of the building, as described above. The luminance of the wall, etc. outside is high while that of the inside of the building is low. That is, the high luminance area in the scene, or image, is significantly larger than the low luminance area. In such a case, the exposure control is usually performed such that objects outside, such as the wall, are properly exposed, with the result that the inside of the building is underexposed.

The image 202 includes a rectangle that indicates an area to be subjected to zoom processing or a zoom area. The zoom processing means 102 performs zoom processing on this area.

Referring still to FIG. 2, the image 203 is a result of performing zoom processing on the above indicated area within the image 202. It should be noted, however, that this zoomed image 203 showing the inside of the building is still underexposed since the exposure for this image is the same as that for the input image 201, making it difficult to see what is inside the building. Thus, simply performing zoom processing on an image captured by a monitoring camera, etc. usually does not lead to a properly exposed zoomed image.

To overcome this problem, the histogram processing means 103 shown in FIG. 1 creates a histogram indicating the luminance distribution in the image 203, and the exposure correction processing means 104 shown in FIG. 1 corrects the luminance level of the image 203 so as to generate a properly exposed zoomed image (such as the image 204 shown in FIG. 2). Thus, the present invention provides an image correcting apparatus capable of correcting a zoomed image such that the exposure or luminance of the image is at a proper level.

FIG. 3 shows the image correcting apparatus of the second embodiment, as described above. This image correcting apparatus differs from that shown in FIG. 1 in that it additionally includes a recording medium.

Referring to FIG. 3, the image signal input to the image input I/F 301 is either subjected to zoom processing as in FIG. 1 or stored on the recording medium 306. When an image signal stored on the recording medium 306 is reproduced, the zoom processing means 302 performs zoom processing on a specified area of the image. Then, the exposure correction processing means 304 corrects the zoomed area such that the exposure or luminance of the area is at a proper level, as in the first embodiment. The image input to the image input I/F 301 and directly subjected to zoom processing is also processed in the same manner as in the first embodiment.

FIG. 4 shows the image correcting apparatus of the third embodiment, as described above. This image correcting apparatus differs from that shown in FIG. 3 in that it includes a mask processing means 402 instead of the zoom processing means 302.

Referring to FIG. 4, the image signal input to the image input I/F 401 is either subjected to mask processing or stored on the recording medium 406, as in FIG. 3. When an image signal stored on the recording medium 306 is reproduced, the mask processing means 402 performs mask processing on a specified area of the image signal. It should be noted that this specification is done manually or automatically.

Then, the histogram processing means 403 creates a luminance histogram of the unmasked area (not the masked area) of the image signal. Then, the exposure correction processing means 404 performs exposure correction on the image signal that has been subjected to the zoomed processing, based on the histogram indicating the luminance distribution in the unmasked area created by the histogram processing means 403. After the above exposure correction processing, the resultant image data is output to an external monitor, etc. through the image output I/F 405.

FIG. 5 shows exemplary images generated by the image correcting apparatus shown by the block diagram of FIG. 4. In the image 501 in FIG. 5, the inside of the building is underexposed, as in the case of the input image 201 in FIG. 2.

The image 502 is a result of performing mask processing on a specified area of the image 501. In the image 502, a shaded rectangle indicates the masked area.

It should be noted, however, that the inside of the building in the image 502 that has been subjected to the mask processing is still underexposed since the exposure for this image is the same as that for the input image 501, making it difficult to see what is inside the building. Thus, when an image captured by a monitoring camera, etc. is subjected to mask processing, the unmasked area of the image usually does not have an appropriate luminance level if ordinary exposure control has been used to capture the image, as in the first and second embodiments.

To overcome this problem, the histogram processing means 403 shown in FIG. 4 creates a histogram indicating the luminance distribution in the unmasked area of the image 502, and the exposure correction processing means 404 shown in FIG. 4 corrects the luminance level of the image 502 such that the exposure or luminance of the unmasked area is at a proper level. Thus, the present invention provides an image correcting apparatus capable of correcting an image having a masked portion such that the exposure or luminance of the image is at an appropriate level.

FIG. 6 shows an image correcting apparatus according to a fourth embodiment of the present invention. This image correcting apparatus differs from that shown in FIG. 1 in that it includes a processor 602 instead of the zoom processing means 102, the histogram processing means 103, and the exposure correction processing means 104 shown in FIG. 1.

According to this embodiment, software in memory (not shown) causes the processor 602 to function as the zoom processing means 102, the histogram processing means 103, and the exposure correction processing means 104 shown in FIG. 1. Referring to the block diagram of FIG. 6, the processor 602 performs image correction on the image signal input to the image signal input I/F 601 such that the exposure or luminance of the image signal is at an appropriate level, as in FIG. 1.

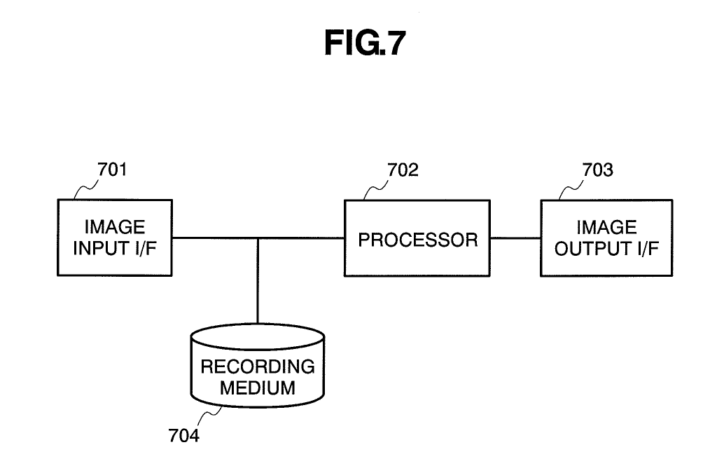

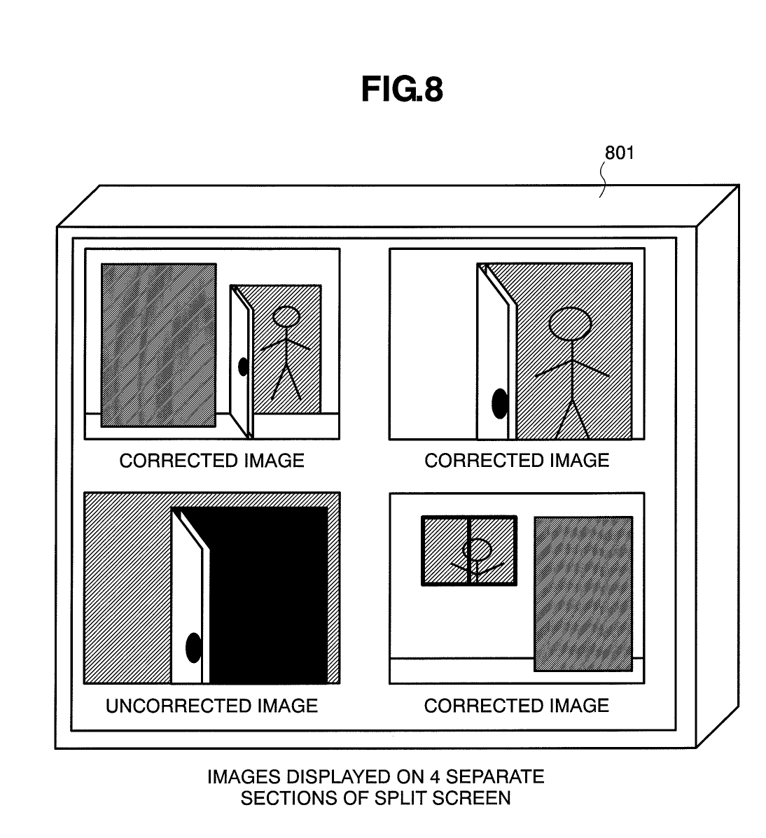

FIG. 7 shows an image correcting apparatus according to a fifth embodiment of the present invention. This image correcting apparatus differs from that shown in FIG. 6 in that it additionally includes a recording medium.

Referring to FIG. 7, when an image signal stored on the recording medium 704 is reproduced, the image correcting apparatus performs image correction on the image signal such that the exposure or luminance of the image signal is at an appropriate level, as in FIG. 3.

FIG. 8 shows a split screen display made up of 4 sections each displaying a different image.

The image correcting apparatus shown in FIG. 1 may be adapted to be able to display a split screen made up of an appropriate number of sections and perform image correction processing on the image displayed on each section separately. This allows the image correcting apparatus to correct the exposure or luminance level of each image, as in FIG. 1.

Although the split screen shown in FIG. 8 is made up of 4 sections, a split screen including any number of sections may be used. Further, the image correcting apparatuses of the second to fifth embodiments also can be adapted to be able to display a split screen and perform image correction processing on the image displayed on each section of the screen separately.

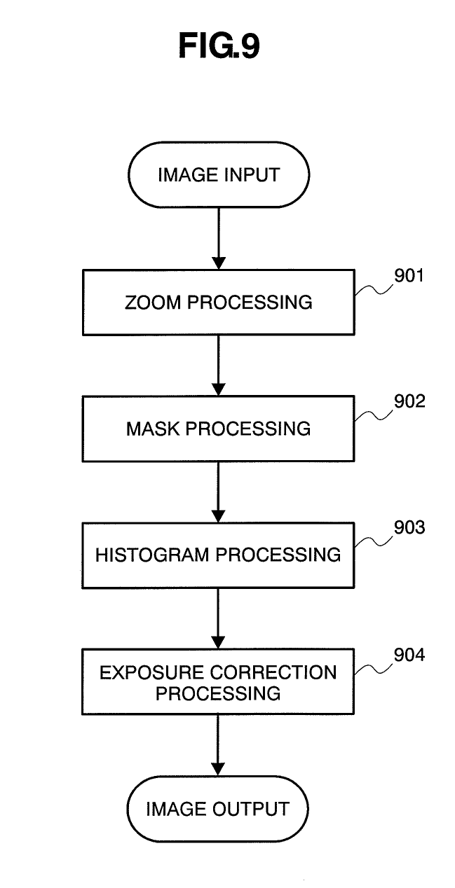

FIG. 9 is a flowchart showing a image correction process according to the present invention.

This process includes both zoom processing 901 and mask processing 902. However, either one of them may be omitted depending on the image correcting apparatus used. The image that has been subjected to zoom processing and/or mask processing is subjected to histogram processing 903. Then, exposure correction processing 904 is performed on the image based on the results of the histogram processing or based on a created histogram to correct the image.

It should be noted that in the above embodiments, the image input I/F and the image output I/F may handle either analog signals or digital signals.

Thus, the present invention provides image correcting apparatuses having enhanced performance.

While we have shown and described several embodiments in accordance with our invention, it should be understood that disclosed embodiments are susceptible to changes and modifications without departing from the scope of the invention. Therefore, we do not intend to be bound by the details shown and described herein but intend to cover all such changes and modifications as fall within the ambit of the appended claims.

What is claimed is:

1. An image correcting apparatus comprising:
reproducing means for reading image information stored on a recording medium and reproducing a screen image represented by said image information;
extracting means for extracting an area of said image reproduced by said reproducing means;
luminance histogram processing means for creating a luminance histogram of said area extracted by said extracting means;
exposure correction processing means for, based on said luminance histogram created by said luminance histogram processing means, correcting the exposure or luminance level of said area extracted by said extracting means; and
output unit for outputting image information on said area to display means after said correction of said exposure of said area.

2. The image correcting apparatus as claimed in claim 1, wherein said extracting means performs zoom processing or mask processing or both to extract said area of said image.

3. An image correcting apparatus comprising:
reproducing means for reading image information stored on a recording medium and reproducing a screen image represented by said image information;
zoom processing means for zooming an area of said image reproduced by said reproducing means;
luminance histogram processing means for creating a luminance histogram of said area zoomed by said zoom processing means;
exposure correction processing means for, based on said luminance histogram created by said luminance histogram processing means, correcting the exposure or luminance level of said area zoomed by said zoom processing means; and
an output interface for outputting image information on said zoomed area to display means after said correction of said exposure of said zoomed area.

4. The image correcting apparatus as claimed in claim 3, further comprising:
mask processing means for masking a portion of said area zoomed by said zoom processing means;
wherein said luminance histogram processing means creates a luminance histogram of the unmasked portion of said area; and
wherein based on said luminance histogram created by said luminance histogram processing means, said exposure correcting means corrects the exposure (or luminance level) of said unmasked portion of said area zoomed by said zooming means.

5. An image correcting apparatus comprising:
reproducing means for reading image information stored on a recording medium and reproducing a screen image represented by said image information;
mask processing means for masking an area of said image reproduced by said reproducing means;
luminance histogram processing means for creating a luminance histogram of the unmasked area of said image;
exposure correction processing means for, based on said luminance histogram created by said luminance histogram processing means, correcting the exposure or luminance level of said unmasked area of said image; and
an output interface for outputting image information on said unmasked area to display means after said correction of said exposure of said unmasked area.

6. The image correcting apparatus as claimed in claim 5, further comprising:
zoom processing means for zooming a portion of said unmasked area of said image;
wherein said luminance histogram processing means creates a luminance histogram of said zoomed portion of said unmasked area; and
wherein based on said luminance histogram created by said luminance histogram processing means, said exposure correction processing means corrects the exposure or luminance level of said zoomed portion of said unmasked area.

7. An image correcting apparatus comprising:
an input interface for receiving image information representing a screen image;
extracting means for extracting an area of said image represented by said image information received by said input interface;
luminance histogram processing means for creating a luminance histogram of said area extracted by said extracting means;
exposure correcting means for, based on said luminance histogram created by said luminance histogram processing means, correcting the exposure or luminance level of said area extracted by said extracting means; and
an output interface for outputting image information on said area to display means after said correction of said exposure of said area.

8. The image correcting apparatus as claimed in claim 1, wherein when an area of said screen image reproduced by said reproducing means is manually or automatically extracted, a luminance histogram of said area is created and the exposure or luminance level of said area is corrected by said exposure correction processing means.

9. The image correcting apparatus as claimed in claim 7, wherein when zoom processing is manually or automatically performed on a specific portion of said screen image represented by said image information received by said input interface, a luminance histogram of said specific portion is created and the exposure or luminance of said specific portion is adjusted to an appropriate level by said exposure correction processing means.

10. An image correcting apparatus comprising:
a recording medium interface for reading image information stored on a recording medium;
memory for storing part or all of said image information and particular software, said image information having been received from said recording medium interface;
an output interface for outputting image information to a display device; and
a processor for, by use of said particular software, performing control so as to:
extract an area of an image represented by said image information temporarily stored in said memory, said image information having been received from said recording medium interface;
create a luminance histogram of said area;
correct the exposure or luminance level of said area based on said luminance histogram; and
output image information on said area to said display device through said output interface after said correction of said exposure of said area.

11. The image correcting apparatus as claimed in claim 7, wherein when one or more images are displayed on different sections or child windows of a split screen, any selected one of said one or more images is corrected independently.
